(19) United States
(12) Patent Application Publication
(10) Pub. No.: US 2025/0255771 A1
(43) Pub. Date: Aug. 14, 2025

(54) OPHTHALMIC DEVICES FOR MANAGEMENT OF WATER VAPOR TRANSMISSIBILITY, DELIVERY OF PHARMACEUTICAL AGENTS, AND NON-SURGICAL CORNEAL RESHAPING

(71) Applicant: OCULAR SURFACE INNOVATIONS INC., Jupiter, FL (US)

(72) Inventors: Jerome LEGERTON, Jupiter, FL (US); John Gelles, Teaneck, NJ (US); Philipp Jens Andre Polonyi, Jupiter, FL (US)

(21) Appl. No.: 19/048,621

(22) Filed: Feb. 7, 2025

Related U.S. Application Data
(60) Provisional application No. 63/551,493, filed on Feb. 8, 2024.

(51) Int. Cl. A61H 5/00; B29D 11/00; B29K 83/00

(52) U.S. Cl. CPC A61H 5/00; B29D 11/00038; A61H 2201/168; A61H 2201/1697; B29K 2083/00; B29K 2995/0065

(57) ABSTRACT

Ophthalmic devices and related methods are provided for management of water vapor transmissibility, delivery of pharmaceutical agents, and non-surgical corneal reshaping. In some embodiments, an ophthalmic device comprises an anterior surface facing away from an eye, a posterior surface facing toward the eye, a medium residing between the anterior surface and the posterior surface, wherein the medium has an oxygen permeability and a water vapor permeability, a first region having a first thickness of the medium, the first region having a water vapor transmissibility above a first minimum value and an oxygen transmissibility above a second minimum value, and a second region having a second thickness of the medium, the second region having a water vapor transmissibility below a third minimum value and an oxygen transmissibility above a fourth minimum value, wherein the second thickness is greater than the first thickness.

### REFERENCE TO RELATED APPLICATIONS

This application claims the benefit of U.S. Provisional Application No. 63/551,493, filed on Feb. 8, 2024, the content of which is incorporated herein by reference in its entirety.

### BACKGROUND

Corneal refractive therapy, also called orthokeratology or kerato-reformation, is a successful non-surgical modality for the temporary reducing of refractive errors of the eye by means of reshaping the cornea. Rigid corneal contact lenses are worn on the eye overnight and removed in the morning. The corneal epithelium has been measured to change in thickness by way of cell shape and the number of epithelial cell layers. The lenses for treatment are now in their fourth generation of design. An example of a fourth generation may be found in U.S. Pat. No. 11,774,779. The rigid corneal refractive therapy lens is passive with regard to any internal forces and relies on compression forces and squeeze angles to cause the epithelium to thin under zones of compression and thicken under zones of relief. The compression force is understood to be created by the negative pressure that causes the aligned lens surfaces to draw closer to the underlying corneal surfaces as taught by the above referenced issued US patent.

Rigid contact lens gas permeable polymers are understood to have a modulus of elasticity similar to while lower than their non-gas permeable forerunner, polymethylmethacrylate (PMMA). The modulus of elasticity for contact lens materials is frequently reported in MPa or megapascals which may be converted from measured values in kgf/cm² or from GPa (gigapascals). The modulus of elasticity of PMMA is reported as 2.4 to 3.4 GPa. This gigapascal value converts to 2400 to 3400 MPa. Common commercialized rigid gas permeable materials are reported to have a modulus of elasticity range from 800 to 1200 MPa. The modulus of elasticity of rigid gas permeable materials is inversely correlated with their oxygen permeability (Dk).

### SUMMARY

In accordance with one or more embodiments, an ophthalmic device comprises: (i) an anterior surface facing away from an eye; (ii) a posterior surface facing toward the eye, a medium residing between the anterior surface and the posterior surface, wherein the medium has an oxygen permeability and a water vapor permeability; (iii) a first region having a first thickness of the medium, the first region having a water vapor transmissibility above a first minimum value and an oxygen transmissibility above a second minimum value; and (iv) a second region having a second thickness of the medium, the second region having a water vapor transmissibility below a third minimum value and an oxygen transmissibility above a fourth minimum value. The second thickness can be greater than the first thickness, and wherein the third minimum value is greater than the first minimum value.

In some embodiments, the posterior surface comprises a clearance region where the posterior surface does not contact the underlying eye, and an annular region where the posterior surface contacts the underlying eye to seal the clearance region. According to certain embodiments, the medium has a water vapor permeability of greater than 10,000 Barrers. In further embodiments, the medium has an oxygen permeability of greater than 100 Barrers. In some cases, the first minimum value is 13,887 Barrers/cm, and the third minimum value is 15,000 Barrers/cm. In other cases, the second minimum value is 80×10−9 (cm×ml O2)/(sec×ml×mmHg), and the fourth minimum value is 80×10−9 (cm×ml O2)/(sec×ml×mmHg). In some embodiments, an area of the first region is greater than twenty square millimeters.

According to further embodiments, a method of forming an ophthalmic device comprises: (i) providing a medium between an anterior surface of the ophthalmic device and a posterior surface of the ophthalmic device; (ii) forming a first region in the medium, the first region having a first thickness, a water vapor transmissibility above a first minimum value, and an oxygen transmissibility above a second minimum value; and (iii) forming a second region in the medium, the second region having a second thickness, a water vapor transmissibility below a third minimum value and an oxygen transmissibility above a fourth minimum value, wherein the second thickness is greater than the first thickness, and wherein the third minimum value is greater than the first minimum value. The method may further comprise forming a clearance region in the posterior surface where the posterior surface does not contact the underlying eye.

In additional embodiments, an ophthalmic device comprises: (i) an anterior surface facing away from an eye; (ii) a posterior surface facing toward the eye, a medium residing between the anterior surface and the posterior surface, wherein the medium has a permeability that is limited to the polar surface area or molecular weight of a permeant, an oxygen permeability, and a water vapor permeability; (iii) a first region having a first thickness of the medium, the first region having a water vapor transmissibility above a first minimum value and an oxygen transmissibility above a second minimum value; and (iv) a second region having a second thickness of the medium, the second region having a water vapor transmissibility below a third minimum value and an oxygen transmissibility above a fourth minimum value. The second thickness can be greater than the first thickness, and wherein the third minimum value is greater than the first minimum value.

Yet another embodiment involves a method of forming an ophthalmic device comprising: (i) providing a medium between an anterior surface of the ophthalmic device and a posterior surface of the ophthalmic device, wherein the medium has a permeability that is limited to the polar surface area or molecular weight of a permeant, an oxygen permeability, and a water vapor permeability; (ii) forming a first region in the medium, the first region having a first thickness, a water vapor transmissibility above a first minimum value and an oxygen transmissibility above a second minimum value; and (iii) forming a second region in the medium, the second region having a second thickness, a water vapor transmissibility below a third minimum value and an oxygen transmissibility above a fourth minimum value, wherein the second thickness is greater than the first thickness, and wherein the third minimum value is greater than the first minimum value.

In another embodiment, an ophthalmic device comprises: (i) an anterior surface facing away from an eye; (ii) a posterior surface facing toward the eye; (iii) a medium residing between the anterior surface and the posterior surface, wherein the medium has an oxygen permeability and a water vapor permeability; and (iv) multiple layers, wherein at least one of the multiple layers has intentional strain energy that acts as a force on a region of the underlying cornea, and wherein the force changes the shape of the underlying cornea.

In a further embodiment, a method of forming an ophthalmic device comprises: (i) providing a medium between an anterior surface of the ophthalmic device and a posterior surface of the ophthalmic device, wherein the medium has an oxygen permeability and a water vapor permeability; and (ii) providing multiple layers, wherein at least one of the multiple layers has intentional strain energy that acts as a force on a region of the underlying cornea, and wherein the force changes the shape of the underlying cornea.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an ophthalmic device having an internal layer with strain energy according to some embodiments of the disclosed technology.

FIG. 2 illustrates a five zone ophthalmic device according to some embodiments of the disclosed technology.

FIG. 3 illustrates a four zone ophthalmic device according to some embodiments of the disclosed technology.

FIG. 4 illustrates an ophthalmic device having non-circular zones that may be rotated independently of each other according to some embodiments of the disclosed technology.

FIG. 5 is a side view of an ophthalmic device for treating myopia and the underlying cornea according to some embodiments of the disclosed technology.

FIG. 6 is a side view of an ophthalmic device for treating hyperopia and the underlying cornea according to some embodiments of the disclosed technology.

FIG. 7 is a flowchart illustrating a process for forming an ophthalmic device according to some embodiments of the disclosed technology.

FIG. 8 depicts a block diagram of an example computer system 800 in which embodiments described herein may be implemented.

FIG. 9A is a top view of an ophthalmic device for regulating corneal edema according to some embodiments of the disclosed technology.

FIG. 9B is a side view of the device of FIG. 9A.

FIG. 10A is an image of a corneal thickness map showing geographic edema of an eye due to damaged corneal endothelium in the region of the edema.

FIG. 10B is a top view of an ophthalmic device for treating the eye of FIG. 10A according to some embodiments of the disclosed technology.

FIG. 11A is a thickness map of an eye having a region of profound corneal edema.

FIG. 11B is a thickness map of the eye after wearing a rigid scleral lens and an ophthalmic device designed to increase the water vapor transmissibility over the region of edema.

FIG. 12 is a top view of an ophthalmic device for keeping tissue transplants in position according to some embodiments of the disclosed technology.

FIG. 13 is a side view of the ophthalmic device of FIG. 12.

FIG. 14 is a top view of an ophthalmic device having thick and thin zones to regulate edge strain according to some embodiments of the disclosed technology.

FIG. 15 is a flowchart illustrating a process for forming an ophthalmic device according to some embodiments of the disclosed technology.

FIG. 16A is a top view of an ophthalmic device for delivering a pharmaceutical to the eye according to some embodiments of the disclosed technology.

FIG. 16B is a side view of the device of FIG. 16A.

FIG. 17A is a top view of an ophthalmic device for delivering a pharmaceutical to the eye according to some embodiments of the disclosed technology.

FIG. 17B is a side view of the device of FIG. 17A.

FIG. 18A is a top view of an ophthalmic device for delivering a pharmaceutical to the eye according to some embodiments of the disclosed technology.

FIG. 18B is a side view of the device of FIG. 18A.

FIG. 19A is a table reporting the molecular size of molecules that are permeable and not permeable to a material.

FIG. 19B is a plot of the data presented in the table of FIG. 19A.

FIG. 20 is a flowchart illustrating a process for forming an ophthalmic device according to some embodiments of the disclosed technology.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

### Ophthalmic Device For Non-Surgical Corneal Reshaping

The range of reported values for soft contact lens polymers ranges from low modulus materials at 0.4 MPa to high modulus materials at 1.5 MPa. The significantly higher modulus of rigid gas permeable materials combined with designs having greater thickness produces rigid contact lenses that are orders of magnitude more stiff than soft contact lenses. At the same time, soft contact lenses are known to be more comfortable. The low modulus of soft contact lens materials combined with their generally thinner design profiles limits their usefulness for intentional corneal reshaping. There is an unmet need for a soft contact lens that delivers the performance of rigid contact lenses for non-surgical corneal reshaping for the temporary reduction of refractive errors.

The ophthalmic literature is absent any publication of clinical results of the use of soft contact lenses for the temporary reduction of refractive errors. A fortuitous temporary reduction in myopia with a soft contact lens was discovered when a patient having high myopia wore a contact lens having a high minus dioptric power inside out while sleeping. U.S. Pat. No. 7,556,375 discloses a potential product based on design concepts to create a shape like the inverted lens. Other parties are attempting to create soft contact lenses having shapes similar to corneal refractive therapy/orthokeratology rigid lenses in an effort to achieve soft lens orthokeratology as disclosed in U.S. Pat. No. 8,864,307. However, these lenses have not demonstrated clinical efficacy.

The modulus of elasticity of the primary material of the disclosed invention is preferably equal to or less than 2.0 MPa. More preferably the modulus is equal to or less than 1.5 MPA. In some embodiments, a commercially available ultra-high oxygen permeable polydimethylsiloxane material having an elastic modulus of 0.566 MPA may be used. In other embodiments, silicone elastomer, hydrogel or silicone hydrogel polymers having a range of modulus from 0.4 to 2.0 MPa may be used.

The disclosed technology includes the creation of strain energy within the soft or flexible ophthalmic device that adds a central compression force with or without a secondary peripheral compression force from a second zone of strain energy and/or an adherence force as disclosed herein. The strain energy may be created by multi-layer molding and inserting a layer in the ophthalmic device that has strain energy. In one embodiment the central inward toward the eye strain energy creates a central force inward toward the anterior surface of the cornea that increases the radius of curvature of the central cornea for the temporary reduction of myopia.

A next peripheral zone may have clearance from the underlying cornea to provide relief and a resultant increase in corneal thickness along with a reduction in the local radius of curvature of the treated cornea in the respective region underlying the zone. This next peripheral zone may have strain energy that is directed toward the anterior surface of the lens.

A next peripheral zone may contact that cornea outside the zone of clearance and may have a secondary compression force that presses the corneal epithelium underlying the compression to assist in increasing the tissue thickness under the zone of clearance medial to it. The secondary compression zone may also have an inward directed strain energy intended to increase the compression force on the underlying cornea.

The secondary compression zone may also generate an adherence force that is created by decreasing the thickness of the lens body in the region of the secondary compression zone to create a localized higher water vapor transmissibility of the ophthalmic device between the underlying cornea and the device.

At least one further peripheral zone may have greater thickness for the purpose of reducing the water vapor transmissibility and may have no strain energy or may have a strain energy that is directed toward the anterior surface of the lens and away from the corneal surface. This zone may produce a lens to eye relationship that relieves the compression force and/or adherence from the higher water vapor transmissibility of the secondary compression zone medial to it.

In another embodiment, intended for the temporary reduction of hyperopia, the central zone may have increased thickness and may have clearance from the underlying cornea and a radius of curvature that is shorter than the underlying pretreatment cornea. The next annular zone, i.e. the primary compression zone, may have an inward toward the eye strain energy that creates a force inward toward the underlying anterior surface of the eye. In this embodiment the radius of curvature of the central cornea may decrease for the temporary reduction of hyperopic refractive error.

A next peripheral zone may have a secondary relief or clearance to allow the primary compression zone to achieve a compression force that assists in decreasing the tissue thickness under the primary compression zone. The primary compression zone may also have a reduced thickness to increase an adherence force by way of tear layer pervaporation from the regional high water vapor transmissibility.

The next most peripheral zone may be a secondary compression zone that may also have an inward directed strain energy and/or an adherence force that is created by a localized higher water vapor transmissibility of the ophthalmic device. At least one more peripheral zone may have greater thickness and a lens to eye relationship that relieves the compression force and/or higher water vapor transmissibility.

Multiple embodiments for creating the strain energy are described. In some embodiments, a secondary material or substrate may be molded into the body of the lens. These substrates may be manufactured to have the desired strain energy and direction of strain energy in the respective regions of the device. The secondary materials may have a modulus that is greater than that of the primary substrate of the device, less than that of the primary substrate of the device or equal to that of the primary substrate of the device. The secondary material may have strain energy induced before being molded into the primary substrate of the device or the strain energy may be modulated after the multilayer molding of the device. In some embodiments the modulation of the secondary material may be achieved using electromagnetic radiation directed to specific regions of the secondary material.

One method of producing strain energy is by means of creating a preformed layer of the same material or a second material that has a first profile produced by an anterior surface shape and a posterior surface shape and the material in between. This layer may be understood to have no strain energy. This preformed layer may then be forced to a second profile during a step in the molding process of the device. The layer may have a strain energy that is dependent on the modulus of the material, the thickness of the first profile, and the deviation of the second profile from the first profile.

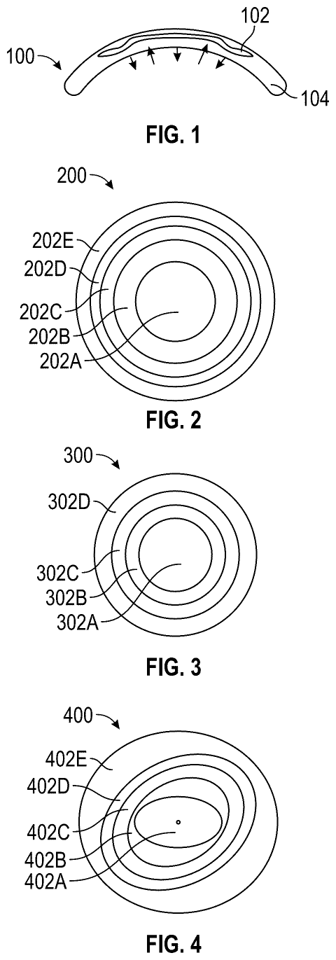

Some embodiments include a soft layer of the same material as the primary substrate that has induced strain energy. FIG. 1 illustrates an ophthalmic device 100 having an internal layer 102 with strain energy according to some embodiments of the disclosed technology. The arrows in FIG. 1 indicate the direction of the strain energy. It appears that the concept of a layer or other means of creating differentials in strain energy in a contact lens for controlling the shape of the lens or for controlling its function for reshaping the pretreatment cornea when placed on the eye has not been previously disclosed. The soft layer 102 of the same material as the primary substrate 104 of the device 100 may be on the posterior surface of the device, within or in a middle layer of the device as shown in FIG. 1, or on the anterior surface of the device.

In some embodiments, the device may manifest a change in the surface shape upon removal from a mold after final curing or after hydration in the case of devices made of silicone hydrogel materials. Embodiments having strain energy in the direction of the posterior surface in the central zone of the device may have a longer measured posterior radius curvature than a device made in the same mold that is absent the strain energy in the direction of the posterior surface in the central zone of the device. Embodiments having strain energy in the direction of the anterior surface in the central zone of the device may have a shorter measured posterior radius curvature than a device made in the same mold that is absent the strain energy in the direction of the anterior surface in the central zone of the device.

In some embodiments, strain decoupling is employed where a peripheral annular zone is included having a thin profile to isolate or minimize the effect of an outermost peripheral zone misalignment induced deformation on the optical or treatment zone of the device. Those skilled in the art should understand that the contour of the globe outside the cornea is known to be asymmetric and that the shallowest and most deep regions of the globe at a chord of 14 mm may vary by as much as 400 microns in axial sagittal depth radially equidistant from the apex of the cornea. Asymmetric thickness of at least one peripheral zone of the device may be used to reduce misalignment induced transferred deformation in the treatment zone of the device with or without circumferential elevation asymmetry in the posterior surface of at least one peripheral zone of the device.

Some embodiments include an annular zone that creates a seal or localized ring of adherence. Thin portions of the device may be designed to create high water vapor transmissibility that lock or adhere the device to the ocular surface.

Some embodiments include an additional annular zone having greater thickness and low water vapor transmissibility that enhances freedom from adherence to assist in the removal of the device at the end of wearing.

In some embodiments the ophthalmic device may have 5 zones, as shown in FIG. 2. In the device 200, the first zone 202A is a central treatment zone, i.e. an optic zone. The posterior surface of the optic zone may be longer in radius and may have inward strain energy for the treatment of myopia. The posterior surface of the optic zone may be shorter in radius with clearance from the underlying cornea with or without outward strain energy for the treatment of hyperopia.

A next peripheral zone 202B may be a relief zone for treating myopia or a compression zone having inward strain energy for treating hyperopia.

A next most peripheral zone 202C may be a compression zone for treating myopia or a relief zone for treating hyperopia.

A next most peripheral seal zone 202D may increase compression force for treating myopia and hyperopia.

A scleral landing zone 202E that terminates in an edge terminus may have increased thickness to provide low water vapor transmissibility and freedom from adherence. The scleral landing zone may be rotationally asymmetric to conform to measured ocular contour or may have a rotational asymmetry derived from biometric mean data. The scleral landing zone may have variable thickness circumferentially for strain decoupling to normalize edge strain to prevent deformation of the treatment zone otherwise caused by differentials in edge strain.

FIG. 3 shows a similar lens 300 with four zones according to some embodiments of the disclosed technology. This lens 300 is similar to the lens 200 of FIG. 2 but omits the outermost landing zone 202E. The remaining zones 302A,B,C,D of the device 300 may be as described above for the zones 202A,B,C,D of the device 200. The embodiment with four zones may have the edge terminus designed at the outermost portion of the seal zone 302D.

All zones may be circular or elliptical due to the cornea being wider horizontally than it is vertically. The zones may be concentric or non-concentric. In some embodiments, non-circular zones of the ophthalmic device may be rotated independently of each other to create an ideal alignment to the underlying eye and improve stability, for example as shown for the device 400 in FIG. 4, which has five zones 402A,B,C,D,E. For instance, if the widest portion of the mid peripheral corneal-limbus ellipse needs to be located at 0/180 degrees but the scleral shape causes the lens to be rotated and stable at 45/225, the mid peripheral corneal-limbus ellipse would otherwise be out of position. Independent zone rotation allows for the landing zone to rest at 45/225 and the mid peripheral corneal-limbus ellipse to be rotated back to 0/180. Methods including the use of splines or linked third order polynomials, Bezier curves, or a plurality of conics may be used to resolve discontinuities when the zones are independently rotated.

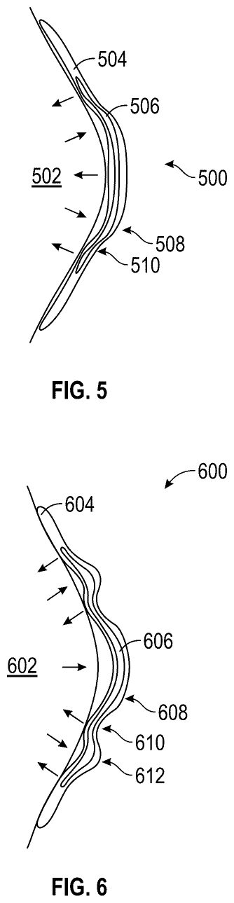

FIG. 5 is a side view of an ophthalmic device 500 for treating myopia and the underlying cornea 502 according to some embodiments of the disclosed technology. The device includes an internal layer 506 within the primary substrate 504 with strain energy having directions indicated by arrows. An inner peripheral zone 508 may be thick to provide low water vapor transmissibility and structural stiffness to provide clearance from the ocular surface. An outer peripheral zone 510 may be thin to provide high water vapor transmissibility which seals the lens 500 to the ocular surface to enhance the compression force.

FIG. 6 is a side view of an ophthalmic device 600 for treating hyperopia and the underlying cornea 602 according to some embodiments of the disclosed technology. The device 600 may include an internal layer 606 within the primary substrate 604 with strain energy having directions indicated by arrows. A central zone 608, and an outer peripheral zone 612, may be thick to provide low water vapor transmissibility and structural stiffness to provide clearance from the ocular surface. An inner peripheral zone 610 may be thin to provide high water vapor transmissibility which seals the lens to the ocular surface.

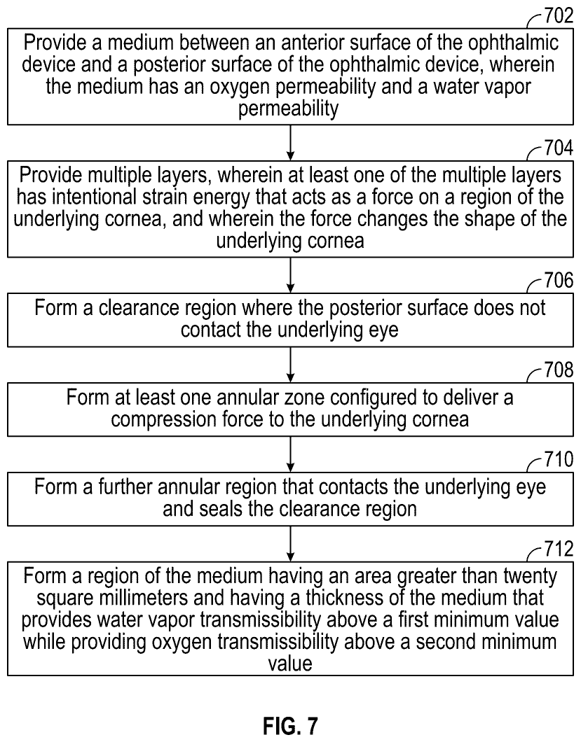

FIG. 7 is a flowchart illustrating a process 700 for forming an ophthalmic device according to some embodiments of the disclosed technology. For example, the process 700 may be employed to form the devices described above with reference to FIGS. 1-6.

The elements of the process 700 are presented in one arrangement. However, it should be understood that one or more elements of the process may be performed in a different order, in parallel, omitted entirely, and the like. Furthermore, the process 700 may include other elements in addition to those presented.

The process 700 may include providing a medium between an anterior surface of the ophthalmic device and a posterior surface of the ophthalmic device, wherein the medium has an oxygen permeability and a water vapor permeability, at 702. The medium may have a water vapor permeability of greater than 10,000 Barrers. The medium may have an oxygen permeability of greater than 100 Barrers.

The process 700 may include providing multiple layers, wherein at least one of the multiple layers has intentional strain energy that acts as a force on a region of the underlying cornea, and wherein the force contributes to changes in the shape of the underlying cornea, at 704.

The process 700 may include forming a clearance region in the posterior surface where the posterior surface does not contact the underlying eye, at 706.

The process 700 may include forming at least one annular zone configured to deliver a compression force to the underlying cornea, at 708.

The process 700 may include forming an annular region in the posterior surface where the posterior surface contacts the underlying eye to seal the clearance region, at 710.

The process 700 may include forming a region of the medium having an area greater than twenty square millimeters and having a thickness of the medium that provides water vapor transmissibility above a first minimum value while providing oxygen transmissibility above a second minimum value, at 712.

Some embodiments include forming at least four zones in the posterior surface of the ophthalmic device. In such embodiments, the force changes the shape of the underlying cornea to correct myopic refractive errors by compression on the central cornea to lengthen the radius of curvature of the central cornea.

In some embodiments, the ophthalmic device has an oxygen transmissibility equal to or greater than 25×10−9 (cm×ml O2)/(sec×ml×mmHg) when the device is indicated for open eye wearing and 80×10−9 (cm×ml O2)/(sec×ml×mmHg) when the device is indicated for closed eye or overnight wearing.

Some embodiments include forming at least four zones in the posterior surface of the ophthalmic device. In such embodiments, the force changes the shape of the underlying cornea to correct hyperopic refractive errors by mid peripheral compression to shorten the radius of curvature of the central cornea.

Some embodiments include forming at least five zones in the posterior surface of the ophthalmic device. In such embodiments, the force changes the shape of the underlying cornea to correct myopic refractive errors by compression on the central cornea to lengthen the radius of curvature of the central cornea.

Some embodiments include forming at least five zones in the posterior surface of the ophthalmic device. In such embodiments, the force changes the shape of the underlying cornea to correct hyperopic refractive errors by mid peripheral compression to shorten the radius of curvature of the central cornea.

Some embodiments include forming a first region having a water vapor transmissibility equal to or greater than 15,000 Barrers/cm, and forming a second region having a water vapor transmissibility of less than 13,887 Barrers/cm.

### Ophthalmic Device For Management Of Water Vapor Transmissibility

Ultrahigh oxygen permeable materials having an oxygen permeability (Dk) of greater than 150 Barrers were introduced more than 40 years ago. They succeeded in use in rigid polymer format while having only limited use in flexible or soft polymers. The early experience in the market of ultrahigh oxygen permeable soft lens materials revealed lens adherence when the lens designs were made in a standard thickness of about 130 microns. Some investigators believed that the lens adherence was caused by hydrophobic surface attraction since the ultrahigh oxygen permeable materials are most often hydrophobic and the cornea of the eye is relatively hydrophobic. Efforts were made to modify the surface of the finished lenses to reduce the wetting angle to make the surfaces more hydrophilic. Coatings or second material layers were attempted to do the same with no resulting commercial success.

Meyers and co-workers claimed the value of adding a differential film layer to the lenses that is more permeable to oxygen than to water vapor. They also described the use of an increased harmonic mean thickness of a single material lens to reduce the water vapor transmissibility to the level of successful commercialized contact lenses that were not made of materials with ultrahigh oxygen permeability while maintaining the oxygen transmissibility at the physiologically required level for corneal health.

Meyers discloses in U.S. Pat. No. 9,869,884 using a harmonic mean lens thickness above a minimum level to reduce water vapor transmissibility below a level that is believed to cause lens adherence. The present disclosure features an apparatus and method that intentionally has regions of the lens that fall below the harmonic mean thickness taught in the above referenced case while having other regions that have greater thickness to reduce the water vapor transmissibility.

There is no evidence that any parties considered the value of lens adherence or the value of creating the intentional high water vapor transmissibility for the purpose of removing water from the underlying tissue, stabilizing lenses, or creating an adherence force for an ophthalmic device to be worn on the surface of an eye.

The present disclosure describes an ophthalmic device to be applied to the anterior surface of the eye and having variable thickness that regulates localized water vapor transmissibility. The ophthalmic device may regulate corneal edema, stabilize the ophthalmic device, create differentials in surface attraction to the underlying eye, and regulate edge strain to reduce optical deformation. Fortuitously, high water vapor transmissibility creates a force to reduce the water in a cornea that is suffering from damage to the corneal endothelium and failure of the cornea to maintain its otherwise low water percentage that keeps it optically clear. The inventors discovered the value in having regional thin zones to assist in removal of water from an otherwise edematous region of the cornea while having other regions that are of greater thickness that may provide release from total adherence by having lower water vapor transmissibility.

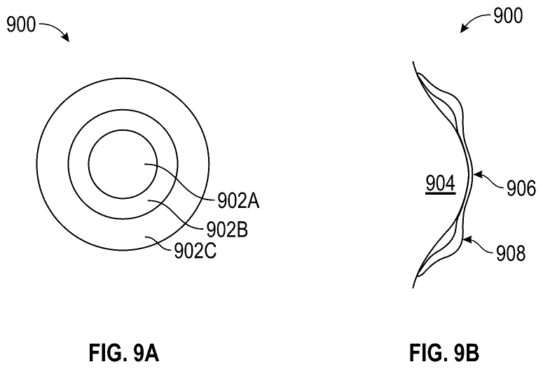

FIG. 9A is a top view of an ophthalmic device 900 for regulating corneal edema according to some embodiments of the disclosed technology. FIG. 9B is a side view of the device 900. The device 900 may have a thin circular central zone 902A for high water vapor transmissibility. The central zone 902A may be surrounded by a thick annulus 902B for reduced water vapor transmissibility and relief of adherence. The thick zone 902B may be surrounded by a scleral landing zone 902C. The thick zone 902B may also vault the underlying cornea by way of a surface profile that maintains clearance from the underlying cornea 904.

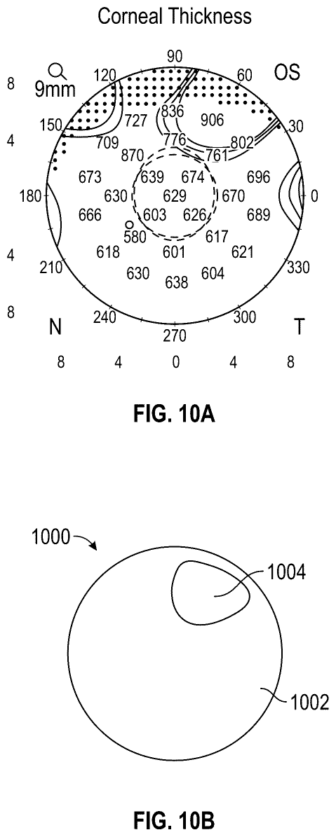

FIG. 10A is an image of a corneal thickness map showing geographic edema of an eye due to damaged corneal endothelium in the region of the edema. The values in FIG. 10A are microns, with 550 to 600 microns being a normal corneal thickness. FIG. 10B is a top view of an ophthalmic device 1000 for treating the eye of FIG. 10A according to some embodiments of the disclosed technology. The device 1000 may have a region 1004 that is thin and shaped like the region of geographic edema. The region 1004 may increase water vapor transmissibility over the region of edema and compromised corneal endothelium to increase local post device tear layer pervaporation and increase a flux of water vapor from the underlying edematous corneal region. In other embodiments, the device may also have a circumferential thick scleral landing zone that decreases water vapor transmissibility and reduces adherence to assist in the removal of the device. The remaining portions 1002 of the lens 1000 may be of standard thickness.

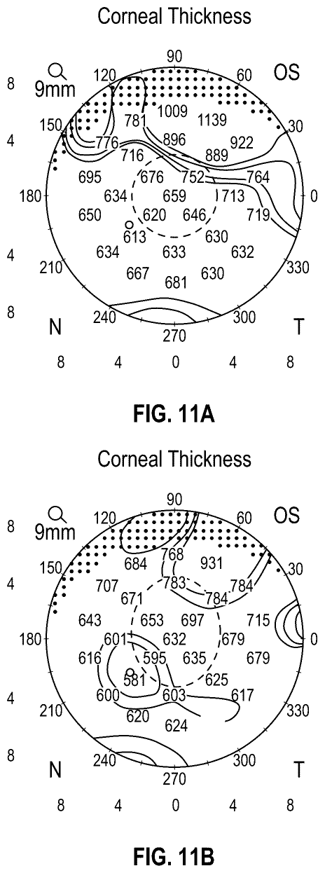

FIG. 11A is a thickness map of an eye having a region of profound corneal edema. FIG. 11B is a thickness map of the eye after wearing a rigid scleral lens and an ophthalmic device designed to increase the water vapor transmissibility over the region of edema.

The modulation of thickness may also be used to increase surface attraction in regions of the ophthalmic device for ophthalmic device stabilization. Some embodiments may include Vapor Controlled Stabilization. The thinner regions may have less stiffness. The stiffness of the ophthalmic device is proportional to the material modulus and proportional to the thickness. The thin regions may reduce stiffness and create more drape to conform to the ocular surface while also promoting higher water vapor transmissibility. The resulting effect may be one of a vapor lock or pervaporation suction force. The ophthalmic device may have value to serve in vapor-controlled suture-less procedures, to keep tissue transplants in position, in anterior lamellar corneal transplant, or in corneal on lay Conjunctival grafts.

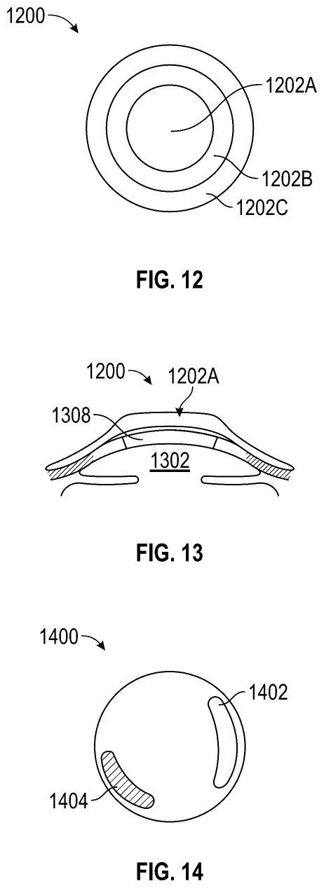

FIG. 12 is a top view of an ophthalmic device 1200 for keeping tissue transplants in position according to some embodiments of the disclosed technology. The device 1200 may have a thick circular center zone 1202A for reduced water vapor transmissibility and freedom from adherence surrounded by a thin annular zone 1202B for increased water vapor transmissibility and an increased adherence force or an intended seal. The outermost zone 1202C may be of average thickness.

FIG. 13 is a side view of the ophthalmic device 1200 of FIG. 12. Also shown in FIG. 13 is a tissue transplant 1308 in the cornea 1302 under the device 1200. The device 1200 may provide a suture-less method of holding the tissue transplant 1308 in place.

Some embodiments of the device may have regions of greater and lesser thickness, and may use variable adherence forces to counter differentials in edge strain that are understood to contribute to lens deformation. FIG. 14 is a top view of an ophthalmic device 1400 having thick and thin zones to regulate edge strain according to some embodiments of the disclosed technology. The thick zones 1404 may increase edge strain, while the thin zones 1402 may reduce edge strain. The remaining portions of the lens may be of standard thickness.

Some embodiments provide Vapor Controlled Stabilization, where thin regions provide adherence to stabilize the ophthalmic device translationally and rotationally.

The modulation of thickness may also be controlled to increase the compression force of an ophthalmic device to assist in delivery of stem cells, electric fields, and other mechanisms that support healing of the underlying eye while having other thicker regions that prevent the ophthalmic device from having complete adherence to the underlying eye.

The term Regional Osmotic Control may be used for an intentional thinner region to induce more water vapor transmissibility. The region may be guided by global corneal tomography and global endothelial cell evaluation to use the water vapor transmissibility to maintain the osmotic force, thereby creating a continuous flux to pull water vapor from the cornea and through the device. In addition, some embodiments achieve the Holden Mertz criteria for closed eye oxygen delivery.

Some embodiments employ spline geometry where knots are placed to regulate the surface shape of the anterior surface, posterior surface, or both surfaces to create differentials in lens thickness with or without intended regions of lens alignment to the underlying ocular surface or intentional non-alignment to the underlying ocular surface.

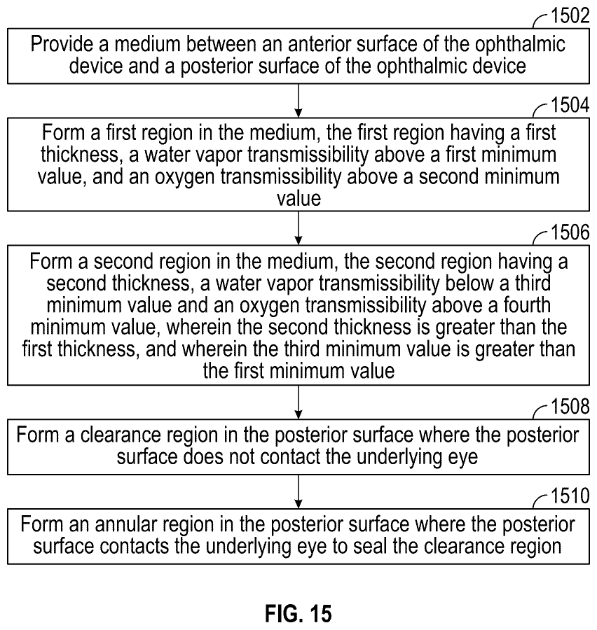

FIG. 15 is a flowchart illustrating a process 1500 for forming an ophthalmic device according to some embodiments of the disclosed technology. For example, the process 1500 may be employed to form the devices described above with reference to FIGS. 1-14.

The elements of the process 1500 are presented in one arrangement. However, it should be understood that one or more elements of the process may be performed in a different order, in parallel, omitted entirely, and the like. Furthermore, the process 1500 may include other elements in addition to those presented.

The process 1500 may include providing a medium between an anterior surface of the ophthalmic device and a posterior surface of the ophthalmic device, at 1502. The medium may have a water vapor permeability of greater than 10,000 Barrers. The medium may have an oxygen permeability of greater than 100 Barrers.

The process 1500 may include forming a first region in the medium, the first region having a first thickness, a water vapor transmissibility above a first minimum value, and an oxygen transmissibility above a second minimum value, at 1504. The first minimum value of oxygen transmissibility may be 80×10−9 (cm×ml O2)/(sec×ml×mmHg). The first minimum value for water vapor transmissibility may be 13,887 Barrers/cm. The area of the first region may be greater than twenty square millimeters.

The process 1500 may include forming a second region in the medium, the second region having a second thickness, a water vapor transmissibility below a third minimum value and an oxygen transmissibility above a fourth minimum value, wherein the second thickness is greater than the first thickness, and wherein the third minimum value is greater than the first minimum value, at 1506. The third minimum value may be 15,000 Barrers/cm and wherein the fourth minimum value of oxygen transmissibility is greater than 80×10−9 (cm×ml O2)/(sec×ml×mmHg).

The process 1500 may include forming a clearance region in the posterior surface where the posterior surface does not contact the underlying eye, at 1508.

The process 1500 may include forming an annular region in the posterior surface where the posterior surface contacts the underlying eye to seal the clearance region, at 1510.

### Ophthalmic Device For The Delivery Of Pharmaceutical Agents

Some embodiments feature an ophthalmic device to be applied to the anterior surface of the eye and having material and design properties that allow for simplified drug delivery to the eye.

Visual impairment and ocular diseases are on the rise globally, making effective drug delivery crucial. Traditional methods like eye drops have limitations, including low bioavailability and challenges in patient compliance to proper dosage and frequency of application.

Drug-delivery contact lenses have emerged as a promising alternative for various ocular diseases, with ongoing advancements expected to impact overall health and quality of life. Multiple parties are working on strategies for drug delivery to the eye. Most include contact lenses with new chemical composition, added nanoparticles, printing the lens surface with the desired agent in particles, loading conventional materials with the pharmaceutical for single use, adding microfluidic structures to the lens structure, or adding micro-electromechanical systems (MEMS) that pump the pharmaceutical agent with or without detection of a clinical marker that triggers the need for the pharmaceutical agent. All of these methods are complicated and challenged by problems of shelf life, storage conditions, cost, and limitations of the pharmaceutical agents that may ever be successfully integrated.

The inventors discovered an ultrahigh Dk lens material that is selective to the transfer of molecules based on their size. For example, the material will transfer oxygen and water vapor but will not transfer sodium chloride. The material has value in reverse osmosis systems because of its selective permeability. Its transmissibility may be regulated by the thickness profile of the ophthalmic device or may be further regulated by the addition of surface modification or fillers within the substrate of the material that produce selective permeability related to polar surface area or the molecular weight of a permeant.

Embodiments of the ophthalmic device may include zones that have volume between the ophthalmic device and the eye to hold a desired volume of a pharmaceutical for continuous delivery. The regions having this volume may be selected to be over the central cornea, the peripheral cornea, the corneo-scleral junction, the sclera, or any combination thereof. Thereby, the region of the ocular surface that is the best match for the pharmaceutical may be controlled by different design permutations of the ophthalmic device. This may be image guided to cover custom areas, for instance a quadrant of the sclera may be targeted to provide focal drug delivery.

Embodiments of the ophthalmic device may provide directional control of drug release. In these embodiments, a void within the material is filled with the desired pharmaceutical, and thickness modification is used for directionally control diffusion. A void with a thin anterior wall and a thick posterior wall causes the pharmaceutical to leach to the anterior surface of the ophthalmic device and prevents posterior surface leach. A void with a thick anterior wall and a thin posterior wall causes the pharmaceutical to leach to the posterior surface of the ophthalmic device. This control may be assisted by micro-fenestrations of the anterior or posterior surface of the ophthalmic device. The voids may be placed regionally in the device.

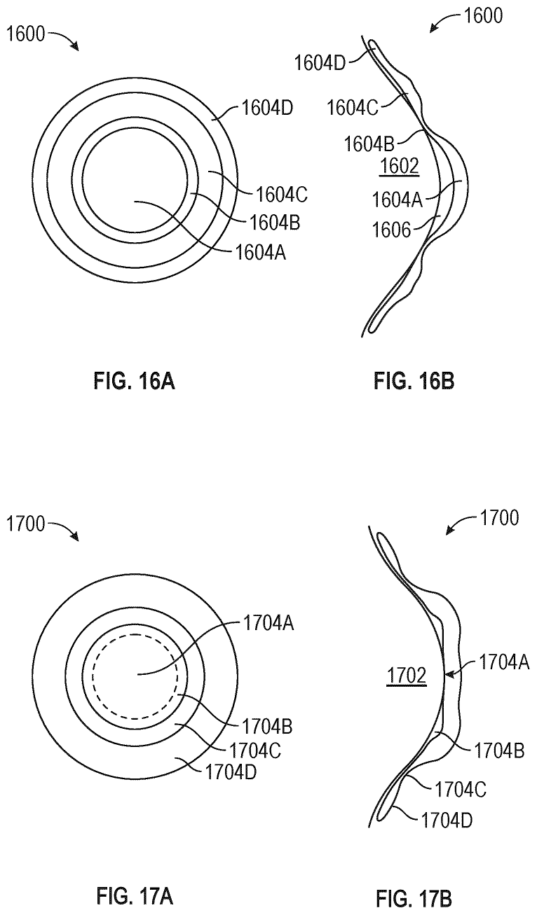

FIG. 16A is a top view of an ophthalmic device 1600 for delivering a pharmaceutical to the eye 1602 according to some embodiments of the disclosed technology. FIG. 16B is a side view of the device 1600. The device 1600 may have a thick circular central zone 1604A for low water vapor transmissibility. The central zone 1604A may be surrounded by a thin annulus 1604B for increased water vapor transmissibility and post device tear pervaporation with resultant intentional adherence or seal. At least one next peripheral zone 1604C may have increased thickness for low water vapor transmissibility and release of adherence. The peripheral zone(s) 1604C may be surrounded by a scleral landing zone 1604D of standard thickness. The thick central zone 1604A may also vault the underlying cornea by way of a surface profile that maintains clearance from the underlying cornea for the purpose of retaining the pharmaceutical agent. Other zones may be of standard thickness.

FIG. 17A is a top view of an ophthalmic device 1700 for delivering a pharmaceutical to the eye 1702 according to some embodiments of the disclosed technology. FIG. 17B is a side view of the device 1700. Compared with the device 1600 of FIGS. 16A,B, this device 1700 has a wider thick circular central zone 1704A for low water vapor transmissibility including an annulus of clearance 1704B from the underlying cornea 1702 to create a circumferential clearance zone for the purpose of retaining the pharmaceutical agent. The central zone (including the annulus of clearance 1704B) may be surrounded by a thin annulus 1704C for increased water vapor transmissibility and intentional adherence or seal. At least one next peripheral zone 1704CD may have increased thickness for low water vapor transmissibility. Other zones may be of standard thickness.

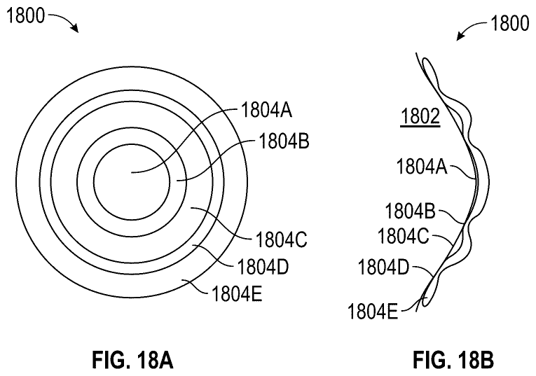

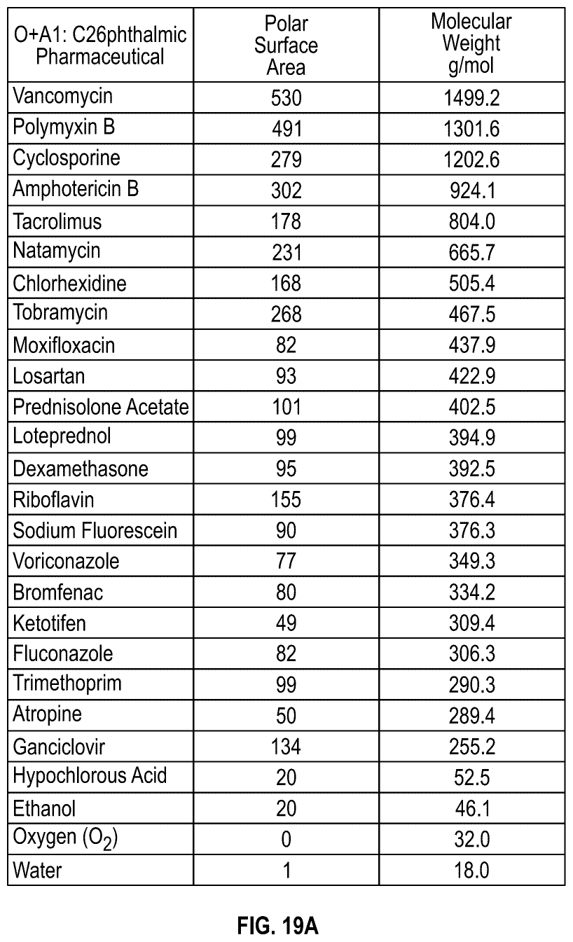

FIG. 18A is a top view of an ophthalmic device 1800 for delivering a pharmaceutical to the eye 1802 according to some embodiments of the disclosed technology. FIG. 18B is a side view of the device 1800. The device 1800 may have a thick circular central zone 1804A for low water vapor transmissibility. The central zone 1804A may be surrounded by a thin annulus 1804B for increased water vapor transmissibility and intentional adherence. At least one next peripheral zone 1804C may have increased thickness for low water vapor transmissibility, and is at a chord diameter that is large enough to be outside the corneo-scleral junction and over the bulbar conjunctiva above the sclera. The thick peripheral zone(s) 1804C that extends over the bulbar conjunctiva may also have a surface profile that maintains clearance from the underlying bulbar conjunctiva for retaining the pharmaceutical agent. This embodiment may include two or more additional annular zones 1804D, 1804E. The inner annular zone 1804D may be a thin annular zone for increased water vapor transmissibility and intentional adherence to seal to the ocular surface to assist in retaining the pharmaceutical agent. At least one outer annular zone 1804E may have increased thickness for low water vapor transmissibility. Other zones may be of standard thickness.

Embodiments of the ophthalmic device may provide incorporated treated material. According to these embodiments, one material species may be modified to achieve desired transmissibility and permeability by exposure to different energy or gases. Layering treated and untreated material may be used to create diffusion gradients. Additionally, custom regional masking with impermeable masking material, followed by exposure to gases or various types of energy, may create diffusion patterns in the material allowing for non-thickness modulated diffusion. This process may also be performed with patterned energy which can be gradiently applied with either variation in exposure time or power. This may be performed during the material cure process or later in the manufacturing.

Modulating thickness to regulate surface attraction may be used to assist in creating a circumferential seal to produce a closed system that prevents the pharmaceutical from releasing outside of the ophthalmic device.

Modulating thickness may also be used to stabilize and prevent movement of the ophthalmic device. Thick zones may be used for initial alignment, ensuring the device is rotated into the correct orientation. Thin zones may be used to create increased surface attraction to further increase stability.

There is no evidence that any parties considered the value of a lens material that is selective to the permeability of molecules based on their size. Early silicone hydrogel contact lens material patents including U.S. Pat. No. 5,760,100 disclosed the intentional property of ion permeability and transfer as a requirement for corneal health. The disclosed embodiments may provide a soft or flexible material that is restrictive to the permeability and transmissibility of ions and molecules that exceed a minimum physical mass or polar surface area.

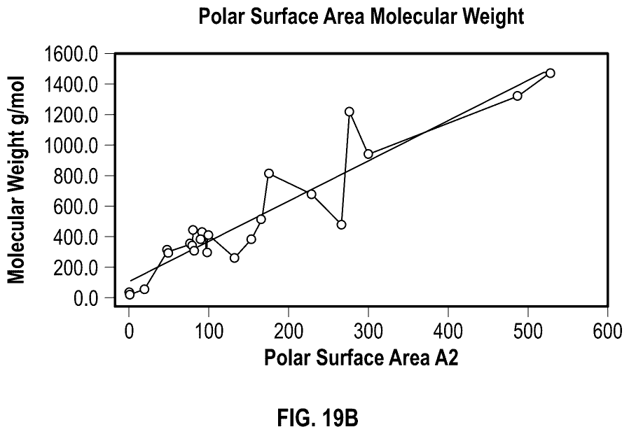

FIG. 19A is a table reporting the molecular size of molecules that are permeable and not permeable to a material. FIG. 19B is a plot of the data presented in the table of FIG. 19A. Molecular weight and polar surface area are correlated with permeability across cell membranes and passive transport through other thin membranes. Table 19A demonstrates that regulating the passive transport transmissibility of a permeant to restrict molecules having a polar surface area of greater than 100 Angstroms squared, or a molecular weight of no greater than 350 g/mol., allows for the simple use of a soft or flexible device of the present invention having at least one clearance zone to retain the liquid or gel pharmaceutical and at least a circumferential seal zone to retain the pharmaceutical in the post device tear space.

In some embodiments, the soft or flexible material selected or the modified soft or flexible material may limit the permeability to a permeant having a polar surface area of no greater than 60 Angstroms squared, or a molecular weight of no greater than 200 g/mol.

Devices having an overall diameter of 14.3 mm made of an optically clear medical grade polydimethylsiloxane with a thickness greater than 0.400 mm were tested with sodium fluorescein, molecular weight 376.3 g/mol and polar surface area 90 angstroms squared and with riboflavin, molecular weight 376.4 g/mol and polar surface area 155 angstroms squared. In each case, the materials were found to be retained in the post lens tear space and were not found in the substrate of the devices after removal or in the pre device tear film during the wearing period. At the same time, the devices are known to have high transmissibility of oxygen, water vapor and ethanol having polar surfaces areas from zero to 20 angstroms squared and molecular weights from 18 to 46 g/mol.

The disclosure describes an ophthalmic device to be applied to the anterior surface of the eye having material properties and geometric design to allow for holding pharmaceutical agents between the posterior surface of the ophthalmic device and the anterior surface of the eye.

Embodiments of the present invention may be used to assist in regulating corneal edema by the additional placement of agents in the space between the posterior surface of the ophthalmic device and the anterior surface of the cornea. Hypertonic saline is one suitable agent. The selective property of the material allowing high water vapor transmissibility creates a force to reduce the water in a cornea that suffers from damage to the corneal endothelium and failure of the cornea to maintain its otherwise low water percentage that is needed to keep the cornea optically clear.

One embodiment may have a region of central clearance between the posterior surface of the ophthalmic device and the anterior surface of the cornea having a thickness of greater than 0.3 mm and preferably greater than 0.4 mm, an annular zone with low thickness, preferably below 0.20 mm, and more preferably below 0.12 mm, surrounding the central clearance that is designed to contact the cornea and to create a seal to trap the agent in the central clearance zone, and at least one annular zone of greater thickness intended to have low water vapor transmissibility to release the ophthalmic device from adherence and allow for easy removal of the ophthalmic device. Additionally, the derivation of thin and thick zones to control edema may be sectorally designed based on observation or image guidance, for instance if a graft is edematous in the inferior region, the corresponding region of the device over the inferior edematous region is thinner. The thickness of the thin zone and the resultant water vapor transmissibility may be proportional to the severity of the edema.

Some embodiments employ spline geometry where knots are placed to regulate the surface shape of the anterior surface, posterior surface, or both surfaces to create differentials in lens thickness with or without intended regions of posterior ophthalmic device surface clearance and ophthalmic device surface alignment to the underlying ocular surface or intentional non-alignment/clearance to the underlying ocular surface.

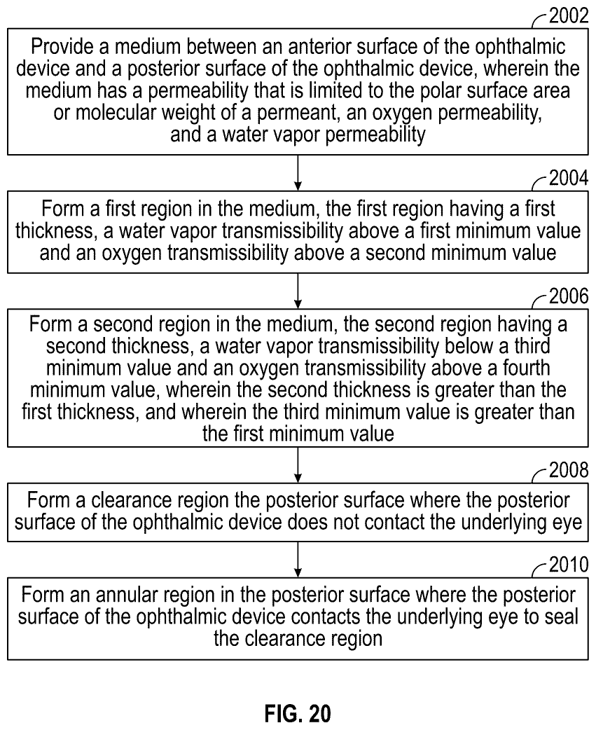

FIG. 20 is a flowchart illustrating a process 2000 for forming an ophthalmic device according to some embodiments of the disclosed technology. For example, the process 2000 may be employed to form the devices described above with reference to FIGS. 16-19.

The elements of the process 2000 are presented in one arrangement. However, it should be understood that one or more elements of the process may be performed in a different order, in parallel, omitted entirely, and the like. Furthermore, the process 2000 may include other elements in addition to those presented.

The process 2000 may include providing a medium between an anterior surface of the ophthalmic device and a posterior surface of the ophthalmic device, wherein the medium has a permeability that is limited to the polar surface area or molecular weight of a permeant, an oxygen permeability, and a water vapor permeability, at 2002. The medium may have a water vapor permeability of greater than 10,000 Barrers. The medium may have an oxygen permeability of greater than 100 Barrers.

The process 2000 may include forming a first region in the medium, the first region having a first thickness, a water vapor transmissibility above a first minimum value and an oxygen transmissibility above a second minimum value, at 2004. The material may have a limitation to its permeability to a permeant having a polar surface area of no greater than 100 angstroms squared or a molecular weight of no greater than 350 g/mol. The first minimum value for water vapor transmissibility may be 13,887 Barrers/cm. The second minimum value may be 25×10−9 (cm×ml O2)/(sec×ml×mmHg). The area of the first region may be greater than twenty square millimeters.

The process 2000 may include forming a second region in the medium, the second region having a second thickness, a water vapor transmissibility below a third minimum value and an oxygen transmissibility above a fourth minimum value, wherein the second thickness is greater than the first thickness, and wherein the third minimum value is greater than the first minimum value, at 2006. The third minimum value may be 15,000 Barrers/cm. The fourth minimum value may be 25×10−9 (cm×ml O2)/(sec×ml×mmHg).

The process 2000 may include forming a clearance region in the posterior surface where the posterior surface does not contact the underlying eye, at 2008.

The process 2000 may include forming an annular region in the posterior surface where the posterior surface contacts the underlying eye to seal the clearance region, at 2010.

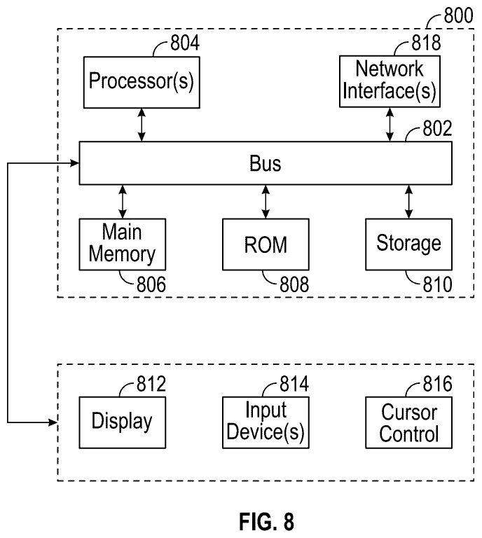

FIG. 8 depicts a block diagram of an example computer system 800 in which embodiments described herein may be implemented. The computer system 800 includes a bus 802 or other communication mechanism for communicating information, one or more hardware processors 804 coupled with bus 802 for processing information. Hardware processor(s) 804 may be, for example, one or more general purpose microprocessors.

The computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

The computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions.

The computer system 800 may be coupled via bus 802 to a display 812, such as a liquid crystal display (LCD) (or touch screen), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. In some embodiments, the same direction information and command selections as cursor control may be implemented via receiving touches on a touch screen without a cursor.

The computing system 800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided or encoded on a computer readable or machine readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative embodiments, hard-wired circuitry may be used in place of or in combination with software instructions.

The term “non-transitory media,” and similar terms, as used herein refers to any non-transitory media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

The computer system 800 also includes a communication interface 818 coupled to bus 802. Network interface 818 provides a two-way data communication coupling to one or more network links that are connected to one or more local networks. For example, communication interface 818 may be an integrated services digital network (ISDN) card, cable modem, satellite modem, or a modem to provide a data communication connection to a corresponding type of telephone line. As another example, network interface 818 may be a local area network (LAN) card to provide a data communication connection to a compatible LAN (or a WAN component to communicate with a WAN). Wireless links may also be implemented. In any such implementation, network interface 818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 818, which carry the digital data to and from computer system 800, are example forms of transmission media.

The computer system 800 can send messages and receive data, including program code, through the network(s), network link and communication interface 818. In the Internet example, a server might transmit a requested code for an application program through the Internet, the ISP, the local network and the communication interface 818.

The received code may be executed by processor 804 as it is received, and/or stored in storage device 810, or other non-volatile storage for later execution.

Each of the processes, methods, and algorithms described in the preceding sections may be embodied in, and fully or partially automated by, code components executed by one or more computer systems or computer processors comprising computer hardware. For example, a method may be referred to as a “computer-implemented” method. The one or more computer systems or computer processors may also operate to support performance of the relevant operations in a “cloud computing” environment or as a “software as a service” (Saas). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalents.

What is claimed is:

1. An ophthalmic device comprising:
an anterior surface facing away from an eye;
a posterior surface facing toward the eye;
a medium residing between the anterior surface and the posterior surface, wherein the medium has an oxygen permeability and a water vapor permeability;
a first region having a first thickness of the medium, the first region having a water vapor transmissibility above a first minimum value and an oxygen transmissibility above a second minimum value; and
a second region having a second thickness of the medium, the second region having a water vapor transmissibility below a third minimum value and an oxygen transmissibility above a fourth minimum value;
wherein the second thickness is greater than the first thickness, and wherein the third minimum value is greater than the first minimum value.

2. The ophthalmic device of claim 1, wherein:
the posterior surface comprises a clearance region where the posterior surface does not contact the underlying eye.

3. The ophthalmic device of claim 2, wherein:
the posterior surface comprises an annular region where the posterior surface contacts the underlying eye to seal the clearance region.

4. The ophthalmic device of claim 1, wherein:
the medium has a water vapor permeability of greater than 10,000 Barrers.

5. The ophthalmic device of claim 1, wherein:
the medium has an oxygen permeability of greater than 100 Barrers.

6. The ophthalmic device of claim 1, wherein:
the first minimum value for water vapor transmissibility is 13,887 Barrers/cm; and
the third minimum value for water vapor transmissibility is 15,000 Barrers/cm.

7. The ophthalmic device of claim 1, wherein:
the second minimum value for oxygen transmissibility is 80×10−9 (cm×ml O2)/(sec×ml×mmHg); and
the fourth minimum value for oxygen transmissibility is 80×10−9 (cm×ml O2)/(sec×ml×mmHg).

8. The ophthalmic device of claim 1, wherein:
an area of the first region is greater than twenty square millimeters.

9. A method of forming an ophthalmic device comprising:
providing a medium between an anterior surface of the ophthalmic device and a posterior surface of the ophthalmic device;
forming a first region in the medium, the first region having a first thickness, a water vapor transmissibility above a first minimum value, and an oxygen transmissibility above a second minimum value; and
forming a second region in the medium, the second region having a second thickness, a water vapor transmissibility below a third minimum value and an oxygen transmissibility above a fourth minimum value, wherein the second thickness is greater than the first thickness, and wherein the third minimum value is greater than the first minimum value.

10. The method of claim 9, further comprising:
forming a clearance region in the posterior surface where the posterior surface does not contact the underlying eye.

11. The method of claim 10, further comprising:
forming an annular region in the posterior surface where the posterior surface contacts the underlying eye to seal the clearance region.

12. The method of claim 9, wherein:
the medium has a water vapor permeability of greater than 10,000 Barrers.

13. The method of claim 9, wherein:
the medium has an oxygen permeability of greater than 100 Barrers.

14. The method of claim 9, wherein:
the first minimum value for water vapor transmissibility is 13,887 Barrers/cm; and
the third minimum value for water vapor transmissibility is 15,000 Barrers/cm.

15. The method of claim 9, wherein:
the second minimum value for oxygen transmissibility is 80×10−9 (cm×ml O2)/(sec×ml×mmHg); and
the fourth minimum value for oxygen transmissibility is 80×10−9 (cm×ml O2)/(sec×ml×mmHg).

16. The method of claim 9, wherein:
an area of the first region is greater than twenty square millimeters.

17. An ophthalmic device comprising:
an anterior surface facing away from an eye;
a posterior surface facing toward the eye;
a medium residing between the anterior surface and the posterior surface, wherein the medium has a permeability that is limited to the polar surface area or molecular weight of a permeant, an oxygen permeability, and a water vapor permeability;
a first region having a first thickness of the medium, the first region having a water vapor transmissibility above a first minimum value and an oxygen transmissibility above a second minimum value; and
a second region having a second thickness of the medium, the second region having a water vapor transmissibility below a third minimum value and an oxygen transmissibility above a fourth minimum value;
wherein the second thickness is greater than the first thickness, and wherein the third minimum value is greater than the first minimum value.

18. The ophthalmic device of claim 17, wherein:
the posterior surface comprises a clearance region where the posterior surface of the ophthalmic device does not contact the underlying eye.

19. The ophthalmic device of claim 18, wherein:
the posterior surface comprises an annular region where the posterior surface of the ophthalmic device contacts the underlying eye to seal the clearance region.

20. The ophthalmic device of claim 17, wherein:
the medium has a water vapor permeability of greater than 10,000 Barrers.

21. The ophthalmic device of claim 17, wherein:
the medium has an oxygen permeability of greater than 100 Barrers.

22. The ophthalmic device of claim 17, wherein:
the medium is limited to a permeant having a polar surface area of no greater than 100 angstroms squared or a molecular weight of no greater than 350 g/mol.

23. The ophthalmic device of claim 17, wherein:
the first minimum value for water vapor transmissibility is 13,887 Barrers/cm; and
the third minimum value for water vapor transmissibility is 15,000 Barrers/cm.

24. The ophthalmic device of claim 17, wherein:
the second minimum value for oxygen transmissibility is 25×10−9 (cm×ml O2)/(sec×ml×mmHg); and
the fourth minimum value for oxygen transmissibility is 25×10−9 (cm×ml O2)/(sec×ml×mmHg).

25. The ophthalmic device of claim 17, wherein:
an area of the first region is greater than twenty square millimeters.

26. A method of forming an ophthalmic device comprising:
providing a medium between an anterior surface of the ophthalmic device and a posterior surface of the ophthalmic device, wherein the medium has a permeability that is limited to the polar surface area or molecular weight of a permeant, an oxygen permeability, and a water vapor permeability;
forming a first region in the medium, the first region having a first thickness, a water vapor transmissibility above a first minimum value and an oxygen transmissibility above a second minimum value; and
forming a second region in the medium, the second region having a second thickness, a water vapor transmissibility below a third minimum value and an oxygen transmissibility above a fourth minimum value, wherein the second thickness is greater than the first thickness, and wherein the third minimum value is greater than the first minimum value.

27. The method of claim 26, further comprising:
forming a clearance region the posterior surface where the posterior surface of the ophthalmic device does not contact the underlying eye.

28. The method of claim 26, wherein:
forming an annular region in the posterior surface where the posterior surface of the ophthalmic device contacts the underlying eye to seal the clearance region.

29. The method of claim 26, wherein:
the medium has a water vapor permeability of greater than 10,000 Barrers.

30. The method of claim 26, wherein:
the medium has an oxygen permeability of greater than 100 Barrers.

31. The method of claim 26, wherein:
the medium is limited to a permeant having a polar surface area of no greater than 100 angstroms squared or a molecular weight of no greater than 350 g/mol.

32. The method of claim 26, wherein:
the first minimum value for water vapor transmissibility is 13,887 Barrers/cm; and
the third minimum value for water vapor transmissibility is 15,000 Barrers/cm.

33. The method of claim 26, wherein:
the second minimum value for oxygen transmissibility is 25×10−9 (cm×ml O2)/(sec×ml×mmHg); and
the fourth minimum value for oxygen transmissibility is 25×10−9 (cm×ml O2)/(sec×ml×mmHg).

34. The method of claim 26, wherein:
an area of the first region is greater than twenty square millimeters.

35. An ophthalmic device comprising:
an anterior surface facing away from an eye;
a posterior surface facing toward the eye;
a medium residing between the anterior surface and the posterior surface, wherein the medium has an oxygen permeability and a water vapor permeability;
multiple layers, wherein at least one of the multiple layers has intentional strain energy that acts as a force on a region of the underlying cornea, and wherein the force changes the shape of the underlying cornea.

36. The ophthalmic device of claim 35, wherein:
the posterior surface comprises at least four zones; and
the force changes the shape of the underlying cornea to correct myopic refractive errors by compression on the central cornea to lengthen the radius of curvature of the central cornea.

37. The ophthalmic device of claim 35, wherein:
the posterior surface comprises at least four zones; and
the force changes the shape of the underlying cornea to correct hyperopic refractive errors by mid peripheral compression to shorten the radius of curvature of the central cornea.

38. The ophthalmic device of claim 35, wherein:
the posterior surface comprises at least five zones; and
the force changes the shape of the underlying cornea to correct myopic refractive errors by compression on the central cornea to lengthen the radius of curvature of the central cornea.

39. The ophthalmic device of claim 35, wherein:
the posterior surface comprises at least five zones; and
the force changes the shape of the underlying cornea to correct hyperopic refractive errors by mid peripheral compression to shorten the radius of curvature of the central cornea.

40. The ophthalmic device of claim 35, wherein the posterior surface comprises:
a clearance region where the posterior surface does not contact the underlying eye; and
at least one annular zone configured to deliver a compression force to the underlying cornea.

41. The ophthalmic device of claim 40, wherein the posterior surface comprises:
a further annular region that contacts the underlying eye and seals the clearance region.

42. The ophthalmic device of claim 35, wherein:
the medium has a water vapor permeability of greater than 10,000 Barrers.

43. The ophthalmic device of claim 35, wherein:
the medium has an oxygen permeability of greater than 100 Barrers.

44. The ophthalmic device of claim 35, further comprising:
a first region having a water vapor transmissibility equal to or greater than 15,000 Barrers/cm; and
a second region having a water vapor transmissibility of less than 13,887 Barrers/cm.

45. The ophthalmic device of claim 35, wherein:
the ophthalmic device has an oxygen transmissibility equal to or greater than 80×10−9 (cm×ml O2)/(sec×ml×mmHg).

46. The ophthalmic device of claim 35, further comprising:
a region of the medium having an area greater than twenty square millimeters and having a thickness of the medium that provides water vapor transmissibility above a first minimum value while providing oxygen transmissibility above a second minimum value.

47. A method of forming an ophthalmic device comprising:
providing a medium between an anterior surface of the ophthalmic device and a posterior surface of the ophthalmic device, wherein the medium has an oxygen permeability and a water vapor permeability; and
providing multiple layers, wherein at least one of the multiple layers has intentional strain energy that acts as a force on a region of the underlying cornea, and wherein the force changes the shape of the underlying cornea.

48. The ophthalmic device of claim 47, further comprising:
forming at least four zones in the posterior surface of the ophthalmic device;
wherein the force changes the shape of the underlying cornea to correct myopic refractive errors by compression on the central cornea to lengthen the radius of curvature of the central cornea.

49. The method of claim 47, further comprising:
forming at least four zones in the posterior surface of the ophthalmic device;
wherein the force changes the shape of the underlying cornea to correct hyperopic refractive errors by mid peripheral compression to shorten the radius of curvature of the central cornea.

50. The method of claim 47, further comprising:
forming at least five zones in the posterior surface of the ophthalmic device;
wherein the force changes the shape of the underlying cornea to correct myopic refractive errors by compression on the central cornea to lengthen the radius of curvature of the central cornea.

51. The method of claim 47, further comprising:
forming at least five zones in the posterior surface of the ophthalmic device;
wherein the force changes the shape of the underlying cornea to correct hyperopic refractive errors by mid peripheral compression to shorten the radius of curvature of the central cornea.

52. The method of claim 47, further comprising:
forming a clearance region in the posterior surface where the posterior surface does not contact the underlying eye; and
forming at least one annular zone configured to deliver a compression force to the underlying cornea.

53. The method of claim 47, further comprising:
forming an annular region in the posterior surface where the posterior surface contacts the underlying eye to seal the clearance region.

54. The method of claim 47, wherein:
the medium has a water vapor permeability of greater than 10,000 Barrers.

55. The method of claim 47, wherein:
the medium has an oxygen permeability of greater than 100 Barrers.

56. The method of claim 47, further comprising:
forming a first region having a water vapor transmissibility equal to or greater than 15,000 Barrers/cm; and
forming a second region having a water vapor transmissibility of less than 13,887 Barrers/cm.

57. The method of claim 47, wherein:
the ophthalmic device has an oxygen transmissibility equal to or greater than 80×10−9 (cm×ml O2)/(sec×ml×mmHg).

58. The method of claim 47, further comprising:
forming a region of the medium having an area greater than twenty square millimeters and having a thickness of the medium that provides water vapor transmissibility above a first minimum value while providing oxygen transmissibility above a second minimum value.
